(19) United States
(12) Patent Application Publication
(10) Pub. No.: US 2020/0008374 A1
(43) Pub. Date: Jan. 9, 2020

(54) PORTABLE HYDROPONIC EBB AND FLOW SYSTEM

(71) Applicant: Fitzpatrick Coleman, Sharon Hill, PA (US)

(72) Inventor: Fitzpatrick Coleman, Sharon Hill, PA (US)

(21) Appl. No.: 16/026,166

(22) Filed: Jul. 3, 2018

(51) Int. Cl. A01G 31/02

(52) U.S. Cl. CPC A01G 31/02; A01G 2031/006

(57) ABSTRACT

A portable hydroponic ebb and flow system has a first container with an open top and a bottom floor. A second container is smaller than and is located within the first container and has through slots located beneath its open top. A third smaller container located within the second container holds the plant and its plant roots. A water pump located on the bottom floor of the first container pumps water to the second container, where the water reaches the plant in the third container. A timing device operates to control the timing intervals in which the pump operates. When the plant is sufficiently watered, the timing device is set to stop the operation of the pump. Excess water which is not absorbed by the plant drains into the second container and ultimately back to the first container via the slots in the second container.

### FIELD OF THE INVENTION

The present invention relates to a portable hydroponic ebb and flow system for watering plants and allowing for rapid removal of non-absorbed water to control the aeration of plant roots.

### BACKGROUND OF THE INVENTION

In hydroponically growing plants, water is periodically pumped to the potted hydroton-filled container in which plant roots are located. After the roots are properly watered, it is necessary to drain the hydroton of excess water in order to ensure that the roots are properly aerated, thus preventing root oversaturation and root rot. As a result, plant roots in these types of systems are alternately watered and aerated between watering periods.

This situation requires that the hydroton, or clay pellets or clay pebbles, surrounding watered roots are drained as rapidly as possible between watering periods. However, while sophisticated and expensive water draining and root aerating systems have been developed to address the growth and preservation of multiple plants in a large system, there are no practical means to ensure that a plant or plants in a single portable container are properly watered and aerated. Attempts to effectively water and drain plants in individual containers consist mostly of estimating the amount of water to be added to a potted plant and then to allow the water to drain back through the hydroton into the bottom of the container or a dish or platform located beneath the container. This method often results in excessive watering and oversaturation of the root systems, especially when water is allowed to remain in the hydroton or the dish in which the container is located.

### SUMMARY OF THE INVENTION

It is thus the object of the present invention to provide a portable hydroponic ebb and flow system which overcomes the limitations and disadvantages of prior systems. The present invention ensures that the plant and its roots which are located in a portable container are properly watered, drained, aerated, and again watered, and that this cycle of watering and aeration is properly timed.

These and other objects are accomplished by the present invention, a portable hydroponic ebb and flow system having three stacked containers. The first or bottom container is enclosed and has an open top and a bottom floor. The second or intermediate container is smaller than and is located within the first container and has upper through slots located beneath its open top. A third smaller container located within the second container holds the plant and its roots. A water pump located on the bottom floor of the first container pumps water via a discharge tube to the second container, where the water ultimately reaches the plant in the third container. A timing device operates to control the timing intervals in which the pump operates. When the plant is sufficiently watered, the timing device is set to stop the operation of the pump. Excess water which is not absorbed by the plant drains into the second container and ultimately back to the first container via the through slots in the second container. In this manner, the plant only accepts and absorbs the water necessary for its healthy growth, while non-absorbed water is drained back to the first container. This allows the plant and plantroots sufficient aeration before water is again pumped to the plant.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an exploded view of the components of the present invention.

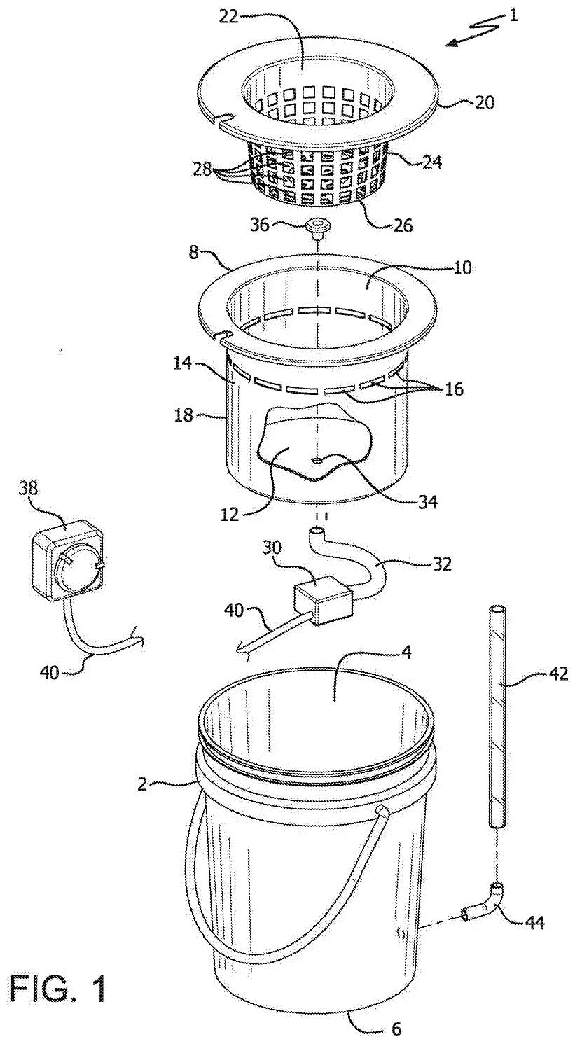

FIG. 2 is a cross-sectional view of the present invention showing its components in the assembled state.

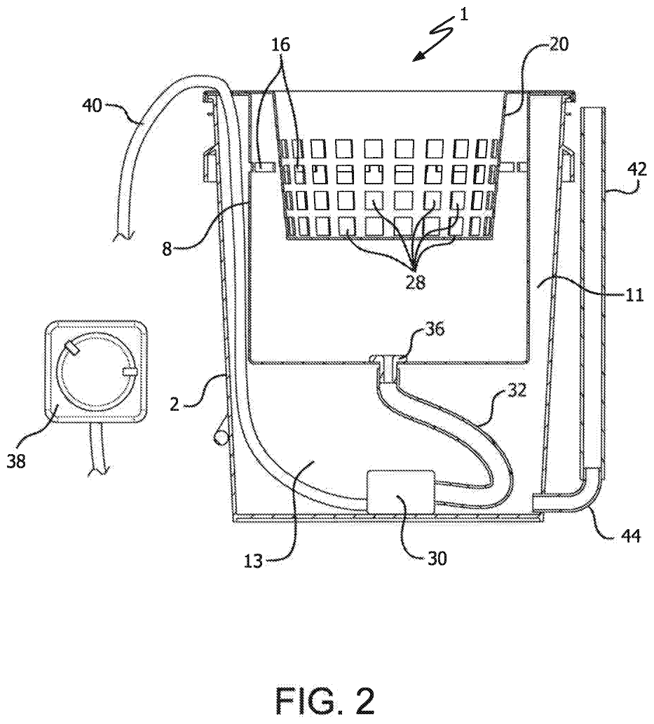

FIG. 3 is a cross-sectional view of the present invention illustrating the plant watering operation.

FIG. 4 is a cross-sectional view of the present invention following the watering operation, during which time the plant roots are aerating.

FIG. 5 is an elevation view of the present invention in which a plant is located.

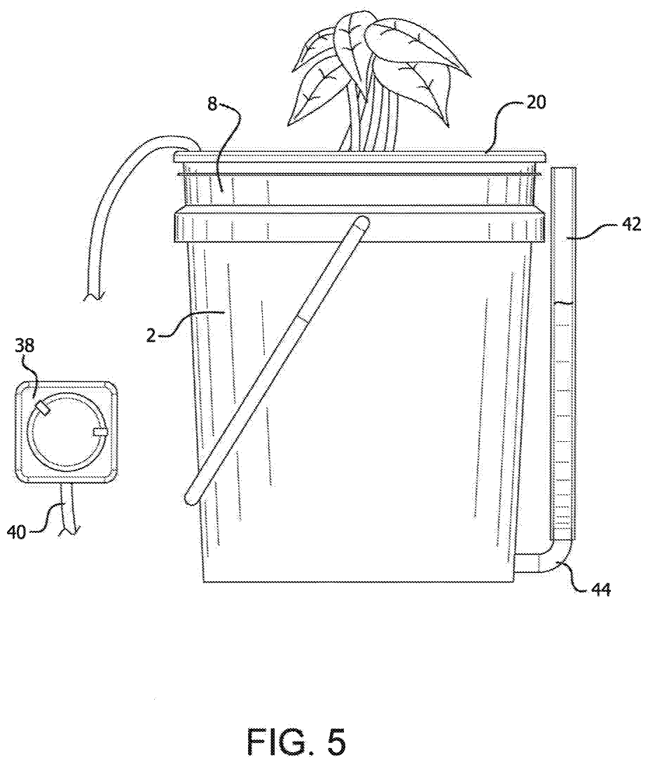

### DETAILED DESCRIPTION OF THE INVENTION

Portable hydroponic ebb and flow system 1 comprises first or bottom enclosed container 2 having open top 4 and bottom floor 6. Second or intermediate container 8 is smaller than first container 2. Second container 8 is located within first container 2 and it has open top 10, bottom 12 floor, and side wall 14 circumscribing the open top. Significantly, second container 8 has upper through slots 16 located beneath open top 10. Side wall 14 has a continuous, uninterrupted wall surface 18 which extends downward from through slots 16 to bottom floor 12 of second container 8. Lateral space 11 is located between first container 2 and second container 8. Bottom space 13 is located between bottom floor 6 of first container 2 and bottom floor 12 of second container 8.

Third or top container 20 is smaller than second container 8 and is located within the second container. Third container 20 is configured to house plant 100 having plant roots 102. Third container 20 has open top 22, side wall 24 circumscribing the open top, and bottom 26. Side wall 24 and bottom 26 have a plurality of spaces 28 extending therethrough.

Water pump or pump means 30 is located on bottom floor 6 of first container 2. Pump 30 supplies water from first container 2 to second container 8 via elongated tube 32 extending from the pump to outlet port 34 and port fitting 36 at bottom floor 12 of second container 8. Electrically operated timer 38 operates, through electrical wiring 40, to control the timing intervals in which pump 30 operates.

The operation of Hydroponic Ebb and Flow System 1 is as follows:

First container 2 is partially tilled with water 50. Sight glass 42 is provided via fitting 44 to show the level of water 50 in first container 2. Containers 2, 8, and 20 are then placed in a stacked configuration. Third container 20 is located within second container 8 and both of these containers are positioned within first container 2. Plant 100 with its roots 102 is placed in hydroton, within third container 20, with the roots extending through spaces 28.

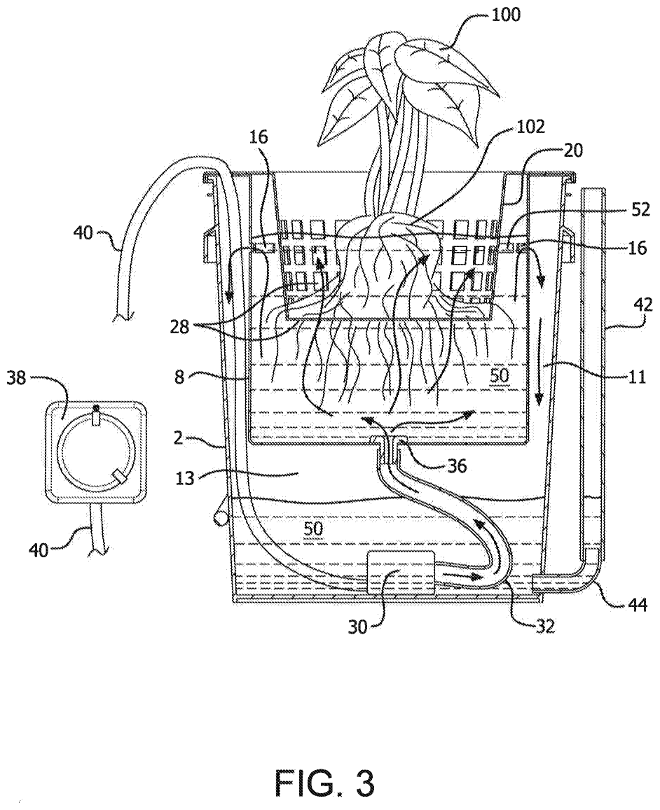

Pump 30 is actuated, as per pre-set timer 38, to pump water 50 via tube 32 and fitting 36 into second container 8. Pumping continues until water level 52 reaches slots 16 in second container 8. See FIG. 3. During this time, water 50 flows through spaces 28 in third container 20, thus irrigating plant 100 and plant roots 102, allowing plant root absorption of the water.

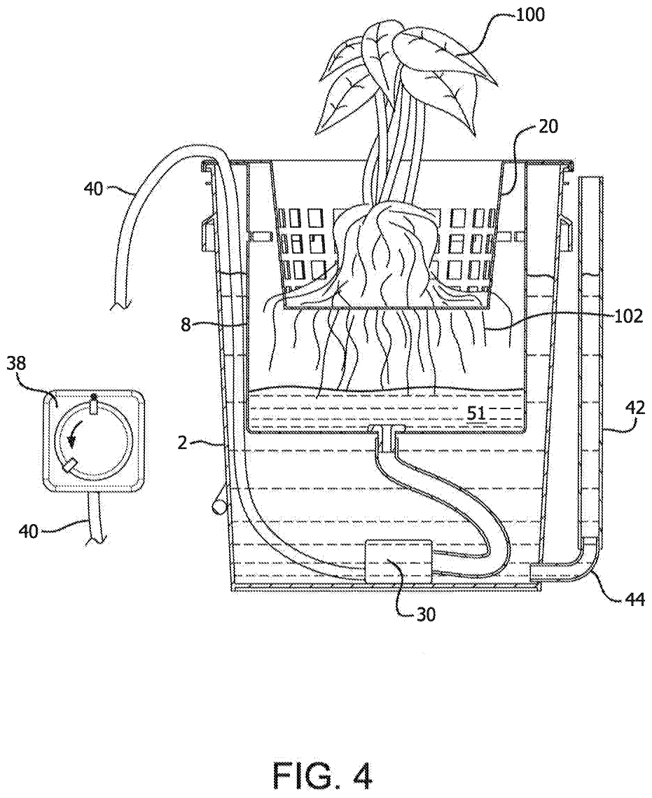

After a predetermined interval of time which is a dependent on the desired amount of desired plant irrigation, timer 38 operates to stop pump 30. Water 50 which has reached slots 16 flows through the slots, down space 11 and into bottom space 13 where it returns to first container 2. Water 50 which has not flowed back to container 2 is absorbed by plant 100 and its roots 102. When absorption is complete, non-absorbed water 51 drains down from the plant and accumulates at the bottom of second container 8. See FIG. 4.

In this manner, plant 100 and its roots 102 are watered for the recommended amount of time and excess water is drained from the plant and roots. The roots are never saturated, but instead, only use necessary absorbed water and are allowed to aerate.

Once watering is again needed, timer 38 is set to actuate pump 30 and the cycle of watering, root absorption and aeration is repeated.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A portable hydroponic ebb and flow system comprising:
a first enclosed container having an open top and a bottom floor;
a second container smaller than the first container located within the first container, said second container having an open top, a bottom, and a side wall circumscribing the open top, the side wall having upper through slots located beneath the open top and a continuous, uninterrupted wall surface extending from the through slots to the bottom of the second container;
a third container smaller than the second container located within the second container for housing a plant and its plant roots, the third container having an open top, a side wall circumscribing the open top of the third container, and a bottom, the side wall and the bottom having a plurality of spaces therethrough; and
pump means located in the first container for supplying water to the second container, whereby water supplied by the pump means to the second container enters the third container through the spaces and is both absorbed by the plant and the plant root in the third container and also flows out the slots in the side wall of the second container and back into the first container.

2. The portable hydroponic ebb and flow system as in claim 1 wherein the pump means is located on the bottom floor of the first container and supplies water via a tube extending from the pump means to the second container.

3. The portable hydroponic ebb and flow system as in clam 2 further comprising a timing device which controls when the pump means supplies water to the second container.

4. The portable hydroponic ebb and flow system as in claim 1 further comprising a timing device which controls when the pump means supplies water to the second container.

5. A stackable hydroponic ebb and flow system comprising:
a bottom container having a floor;
an intermediate container located within the bottom container, the intermediate container comprising an open top, a bottom, and a side wall circumscribing the open top, the side wall having upper through slots located beneath the open top, and a continuous uninterrupted wall surface extending from the through slots to the bottom of the intermediate container;
a top container located in the intermediate container, the top container comprising an open top, a side wall circumscribing the open top of the container, and a bottom, the side wall and bottom having a plurality of spaces therethrough; and
pump means located on the floor of the bottom container for supplying water to the intermediate container, whereby as the water level of the supplied water to the intermediate container rises, the water flows through the spaces into the top container and the slots in the intermediate container.

6. The stackable hydroponic ebb and flow system as in claim 5 wherein the pump means supplies water via a tube extending from the pump means to the second container.

7. The stackable hydroponic ebb and flow system as in claim 6 further comprising a timing device which controls when the pump means supplies water to the second container.

8. The stackable hydroponic ebb and flow system as in claim 5 further comprising a timing device which controls when the pump means supplies water to the second container.

9. A method of watering a plant comprising the steps of:
providing a first container having an open top and a bottom floor;
partially filling the first container with water;
providing a second container smaller than the first container located within the first container, said second container having an open top, a bottom, and a side wall circumscribing the open top, the side wall having upper through slots located beneath the open top and a continuous, uninterrupted wall surface extending from the through slots to the bottom of the second container;
providing a third container smaller than the second container and located within the second container, the third container having an open top, a side wall circumscribing the open top of the third container and a bottom, the third container side wall and bottom having a plurality of spaces therethrough;
positioning a plant having roots within the third container;
pumping water from the first container to the second container;
continuing to pump water until the level of the water reaches the slots of the second container;
allowing the pumped water to flow through the spaces of the third container to the plant and its roots;
irrigating the plant and its roots within the third container with the pumped water to allow plant root absorption of the water;
stopping the pumping of water from he first container;
removing water from the second container by the flow of said water through the slots in the second container;
returning the water from the slots in the second container to the first container; and
after a pre-determined period of time repeating the above steps of the herein method.
